(19) United States
(12) Patent Application Publication
(10) Pub. No.: US 2018/0093872 A1
(43) Pub. Date: Apr. 5, 2018

(54) INDUSTRIAL TRUCK WITH AN OPERATING LEVER AS WELL AS METHOD FOR OPERATING SAID INDUSTRIAL TRUCK

(71) Applicant: Jungheinrich Aktiengesellschaft, Hamburg (DE)

(72) Inventors: Hendrick Geilsdorf, Hamburg (DE); Jörn Sellentin, Kaltenkirchen (DE)

(73) Assignee: Jungheinrich Aktiengesellschaft, Hamburg (DE)

(21) Appl. No.: 15/720,608

(22) Filed: Sep. 29, 2017

(30) Foreign Application Priority Data
Sep. 29, 2016 (DE) 10 2016 118 460.8

(51) Int. Cl. B66F 9/075; G05G 1/04; G05G 5/05

(52) U.S. Cl. CPC B66F 9/0759; B66F 9/07581; G05G 9/02; G05G 5/05; G05G 1/04

(57) ABSTRACT

An operating assembly for an industrial truck comprises an operating lever and a resetting apparatus configured to interact with the operating lever and generate a reset force for the operating lever depending on the deflection of the operating lever. A vehicle function is assigned to the operating assembly and the resetting apparatus is configured to generate a neutral position for the operating lever that corresponds with a current activation of the vehicle function.

### CROSS REFERENCE TO RELATED INVENTION

This application is based upon and claims priority to, under relevant sections of 35 U.S.C. § 119, German Patent Application No. 10 2016 118 460.8, filed Sep. 29, 2016, the entire contents of which are hereby incorporated by reference.

### BACKGROUND

The invention relates to an industrial truck with at least one operating means (or assembly) comprising an operating lever and a resetting apparatus acting together with the operating lever, which generates a reset force for the operating lever depending on its deflection. The invention also relates to a method for operating an industrial truck, which has at least one operating means comprising an operating lever and a resetting apparatus acting together with the operating lever.

Numerous different concepts and approaches for operating elements are known for operating and controlling industrial trucks. For example, an operating element for an industrial truck with two operating levers and at least one switch arranged between them is known from DE 10 2013 012 176. The operating levers are each designed for a bi-axial movement and are spatially separate from each other such that the fingers of a hand positioned between the levers can actuate the operating levers without grasping, and can actuate the at least one switch between the operating levers.

DE 10 2005 000 633 A1 discloses providing vibration in the operating element and/or the driver's seat as feedback for vehicle states and/or vehicle information. This is haptic feedback of vehicle states and/or vehicle information. When the operating element is embodied as a joystick, there is reliable and direct feedback of vehicle states and/or vehicle information by electromagnets generating vibrations, or an electric motor interacting with an unbalanced mass.

Operating elements designed as a joystick are known from DE 10 2014 103 988 A1 for controlling commercial vehicles, machines, work functions of commercial vehicles or construction machines and attachments. The use of force feedback is also known for the joysticks. Force feedback is mechanical feedback which is normally achieved by coupled torque of an electric motor with the assistance of a gear unit. Different technical embodiments of the actuating lever of the joystick are known for implementing force feedback.

A driving and steering control for an industrial truck became known from DE 10 2007 060 336 A1, in which an adjustment element starting from its zero position within an X/Y coordinate system can be deflected with at least two quadrants. A control device may then determine target value signals for the driving speed and for the steering angle from the position of the adjustment element.

An important aspect of operating an industrial truck is the intuitive handling of the operating lever. In particular in the case of a semi-automatic activation or in the case of a position-dependent activation of a vehicle function, it is decisive that the operator intuitively controls the operating lever in the correct manner. During an intervention into an automatic control process, if the user moves the operating lever in an opposite direction, an ambiguity can occur. Steering in the opposite direction either only means to slow the present automatic process or a movement in the opposite direction should take place. In the case of a position-dependent activation in which the position of an element of the industrial truck is specified by a position of the operating lever, such as the mast tilt, an ambiguity can occur. Here, a perpendicular alignment of the lift mast corresponds with the center or neutral position of the operating element. If the actual position of the lift mast now changes due to external influences, then it is not intuitively understandable whether a movement of the operating lever into its center position should tilt the lift mast by a defined distance or cause a perpendicular positioning of the lift mast.

The object of the invention is to provide an industrial truck and a method for intuitive operation with simple means.

### BRIEF SUMMARY OF THE INVENTION

In an embodiment, the industrial truck may have at least one operating means (or assembly), which has an operating lever. By adjusting the operating lever, vehicle functions can be triggered via associated actuators. Furthermore, a resetting apparatus may be provided, which generates a reset force for the operating lever depending on its deflection. In the resetting apparatus, there is an association between the reset force and the deflection of the operating lever. This association can be specified in any manner by the resetting apparatus, such that a value for the reset force is preferably assigned to each deflection.

In an embodiment, the resetting apparatus generates a neutral position for the operating lever, which corresponds with a current activation of the vehicle function. The neutral position of the operating lever here is the position of the operating lever, in which no force needs to be applied in order to hold the operating lever in its position. In the case of a position-dependent activation as well as in the case of an automatic activation of the vehicle function, the neutral position is generated for the operating lever, which would be necessary in the case of the current activation of the vehicle function. The operator, who has for example visual feedback from the current vehicle function and its activation, can already engage in a correcting manner, wherein the operating lever through the neutral position is in a position, which matches the current activation of the vehicle function. A faulty operation through an ambiguous movement of the operating lever is hereby excluded.

In an embodiment, the deflection of the operating lever out of its neutral position leads to the ending of automatic mode. In said embodiment, if the operating lever is moved out of the neutral position, it preferably switches to a manual activation, wherein the current position of the operating lever is then simultaneously the signal for the activation.

In an embodiment, an additional control can take place for a continued automatic mode. In the case of a deflection of the operating lever out of its neutral position in automatic mode, it is continued here and the speed is controlled via the operating lever in continued automatic mode. In said embodiment, the operator has the additional option of continuing this during automatic mode without interrupting the automatic mode and executing the processes of automatic mode at a speed controlled by the operating lever.

In a further embodiment, the resetting apparatus specifies the neutral position for a deflection of the operating lever in an automatic mode for the vehicle function, which matches a position of the operating lever during a manual activation of the vehicle function. Manual activation means that the operating lever with its neutral position has the deflection that the operating lever would have if the vehicle function were not activated automatically but rather through actuation of the operating lever. Without an intervention by the operator, the operating lever in automatic mode always moves like the operating lever would move in the case of a manual activation of the same movement of the automatic function. A movement of the operating lever is clearly determined here as the deflection corresponding with the activation of the vehicle function. Thus if a vehicle function is activated with x−% in automatic mode, then the operating lever with its neutral position is also in an x−% corresponding position. An action in automatic mode through a forward or backwards movement of the operating lever by a deflection of +/−Δ% thus means that the vehicle function is activated with x+Δ% or with x−Δ%.

In an embodiment, the deflection of the operating lever in automatic mode out of a neutral position of a manual activation of the associated vehicle function corresponds with a deflection relative to the neutral position. Even in the case of a position-dependent activation, it can be provided that a neutral position of the operating lever corresponds with a current position of the vehicle function associated with the operating lever.

In an embodiment, a measuring apparatus may be provided, which captures the current position of a component set by the vehicle function and rests against or contacts the resetting apparatus. It is possible via the feedback of the current position to adjust the neutral position according to the current position of the vehicle function. The feedback also makes it possible to react to external influences since a force acting externally on the vehicle function is displayed by the adjusted neutral position of the operating lever.

The method is provided for operating an industrial truck comprising at least one operating means. The operating means may comprise an operating lever and a resetting apparatus that generates a reset force for the operating lever depending on its deflection. A vehicle function is assigned to the operating means, which is activated by a deflection of the control arm. A neutral position may be generated on the operating lever, which corresponds with a current activation of the vehicle function. Through the adjusted neutral position, a control person or user has the correct feedback from the operating lever.

In an embodiment, an automatic mode is provided for the vehicle function. A neutral position with a fading reset force is generated in a position, which corresponds with a manual activation of the vehicle function. In an embodiment, the automatic mode assumes the activation of the vehicle function. The operating lever may follow with its neutral position the current activation so that the operating lever assumes a reset-force-free neutral position during the deflection, which corresponds with the current, automatic activation.

In an embodiment, a deflection of the operating lever out of its neutral position in the automatic mode corresponds with a manual activation of the vehicle function without a changed neutral position. This means that if the neutral position is located in position +x%, a deflection takes place by the amount Δ−% of an activation with a value of x+/−Δ−%. It is hereby ensured to a considerable degree that an operator correctly and intuitively grasps and positions the operating lever as in a manual activation.

The deflection of the operating lever out of the neutral position can correspond with the transition to a manual activation and the ending of automatic mode. Alternatively, it is also possible that automatic mode is continued such that the speed of the automatic function is then controlled by the steering of the operating lever into a position deviating from the neutral position. This means that if the operating lever is moved out of the neutral position, automatic mode is continued and it is continued faster or slower depending on the deflection through which the neutral position was left.

### BRIEF DESCRIPTION OF THE DRAWINGS

A preferred exemplary embodiment of the invention is explained in greater detail below:

FIG. 1 illustrates an embodiment of an operating element; and

FIG. 2 illustrates a schematic view of an example of a shifted neutral position.

### DETAILED DESCRIPTION OF THE INVENTION

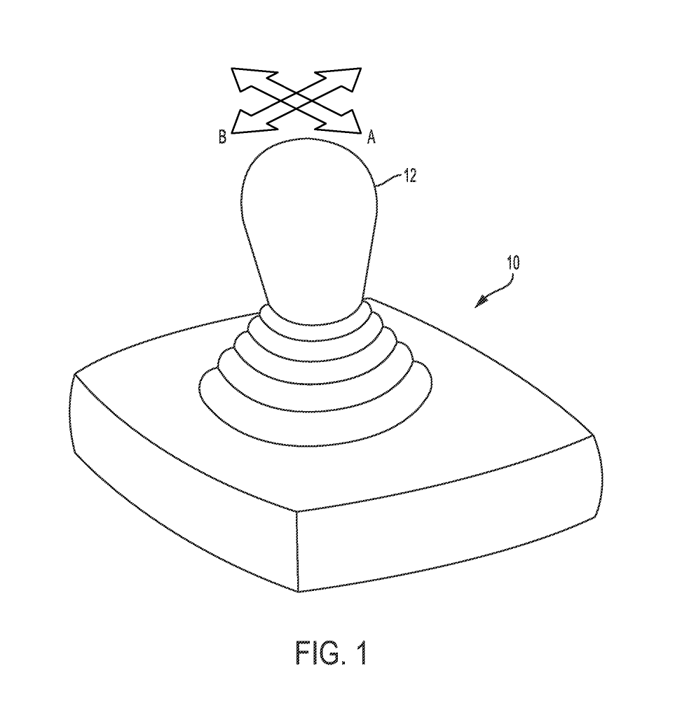

FIG. 1 shows in a simple schematic view an embodiment of an operating element 10 with an operating lever 12 that can be moved independently along the A and B axes. The operating lever 12 may be pivotably mounted on its foot and can be pivoted along the A or B axes independently of each other. The pivoting of the operating lever 12 thereby takes place out of a neutral position, both in a positive as well as in a negative direction. The deflection of the operating lever 12 is thereby restricted in each direction by a maximum deflection. The invention can also be used in the case of an operating lever that can only be pivoted in one direction.

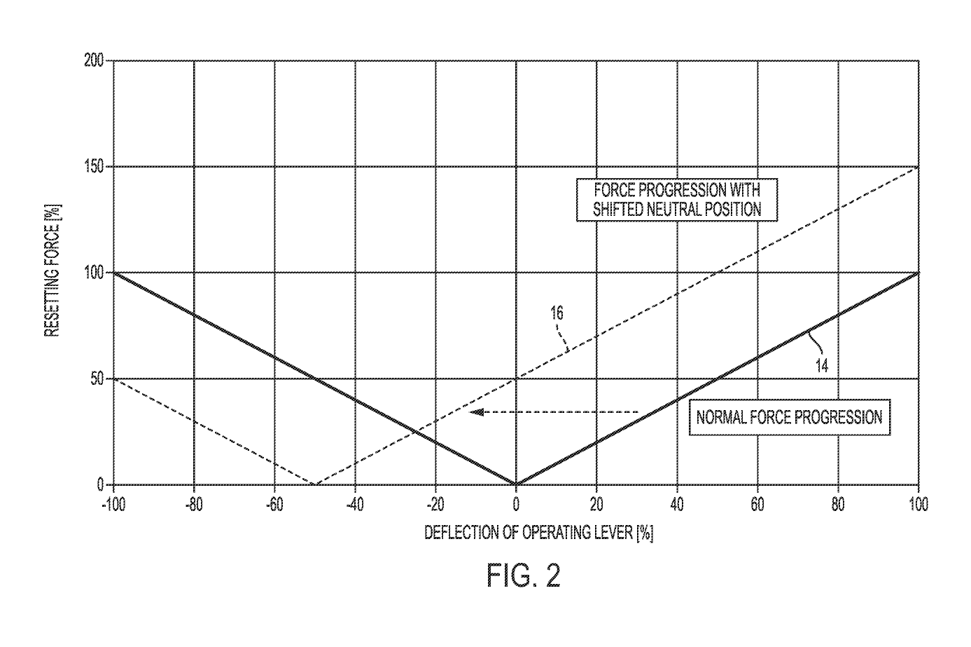

FIG. 2 shows the relationship between a resetting force for the operating lever and the deflection of the operating lever 12. The solid line 14 shows the normal force progression. In the case of normal force progression, no resetting force acts in the case of a deflection of 0%; this is the neutral position. The resetting force then increases respectively to 100% up to the maximum deflections +/−100%. In this embodiment, the operator receives an indication about the magnitude of deflection of the operating lever from the level of the resetting force experienced.

The dashed line 16 shows the force progression in the case of a shifted neutral position. The resetting force hereby disappears in the case of a deflection of −50%. The neutral position is at −50%. The reset force increases linearly up to an increasing deflection and the reset force at +50% deflection exceeds the 100% mark and increases up to a 150% in the case of a deflection in the positive direction. In the case of a more negative deflection of up to +100% deflection, the reset force then increases to a value of up to 50%. At −100%, the maximum deflection is provided so that, although the reset force only reached a value of 50%, a further adjustment of the operating lever to an even more negative deflection is not possible.

The shifting of the neutral position has advantages in industrial trucks that use automatic functions. In said industrial trucks, the currently executed vehicle functions are not generally activated via the operating elements. Despite an executed function, the corresponding operating element usually remains in the center position. If the operator wants to intervene, he must deflect the operating element in the opposite direction, which can then lead to an unclear command. For example, if the vehicle lifts automatically and the driver steers in the direction to lower it, then it is not completely clear whether he wants to slow or respectively stop the automatic movement or whether he wants to lower the load, for example because it was already lifted too high.

By means of the shifted neutral position shown in line 16, the position of the operating element is adjusted at all times to the current command of the automatic function. In the example shown in FIG. 2, an activation currently takes place with a −50% deflection. This means that it is currently lowered through automatic mode at half the speed. If the driver now wants to intervene in this automatic function, then he must correctly control the lever starting from this neutral position in the case of a −50% deflection. In the case of an intervention in automatic mode with its neutral position, several variants can now be differentiated. In the case of the first variant, automatic mode ends through the deflection of the operating lever out of its neutral position. This means that the control takes place manually through the actuation of the operating lever and the current position of the operating lever. In the example of the lifting function, this means that in the case of an adjustment of the operating lever at a lowering speed of −40% it is no longer lowered automatically with −50% but rather the lowering process takes place automatically with −40%. Two further aspects can be differentiated in this change to manual control mode. One aspect concerns the variant that the neutral position specified by automatic mode is retained. This means that in the case of the release of the manually activated lowering speed of −40%, the operating lever returns to its neutral position specified by automatic mode and the lowering process continues with −50%. In said embodiment, a switch from automatic mode to manual mode is only performed as long as the operating lever is guided into a position deviating from the neutral position specified by automatic mode. In another embodiment, the automatic mode is finally ended and when the operating lever is released and returns to its 0%-position as the neutral position and thereby deactivating the lifting function.

In another embodiment, the automatic mode may continue through a deflection of the operating lever and out of its neutral position in the automatic mode, the speed of automatic mode may change through the activation of the operating lever. This means that in the case of a neutral position of −50% specified by automatic mode and a lowering speed of −50%, a deflection of the operating lever into a position of −40% does not effectuate a manual activation with −40%, but rather a continuation of automatic mode, such that the lowering no longer takes place at a lowering speed of −50% but rather with a value corrected by the current deflection. If the one operating lever is then released in this state, it automatically returns to its neutral position currently specified by automatic mode since the automatic mode persists.

The operating levers of an industrial truck normally specify the speed of work functions. A half-deflected operating element may correspond with half the maximum speed of the work function when there is a linear relationship between deflection and activation. For some functions on the industrial truck, the position of the vehicle function may be specified instead of the speed, for example for mast forward reach travel for reach trucks, a lateral reach travel of an attachment or the tilting of the lift mast. In this operation, the speed for the vehicle function is not specified but rather the position of the vehicle function can be specified by the movement of the operating lever. In order to then hold the position, the neutral position of the operating lever of the current position of vehicle is adjusted. In the force progression 14 shown in FIG. 2 with a shifted neutral position, the neutral position corresponds with a mast forward reach travel pushed back by −50% of a reach truck, of a lateral pusher shifted 50% in one direction, or of a lift mast tilted by −50%. In order to then hold the position, the neutral position is shifted so that the operating element also remains unactuated in its new neutral position. In the case of mast forward reach travel, the neutral position can be at a front or rear stop (i.e., it can be ±100% deflection for the neutral position). An advantage of said embodiment is that the operator can feel the position of the vehicle function directly on the operating element even if external forces have adjusted the position of the vehicle function.

1. An operating assembly for an industrial truck comprising:
an operating lever; and
a resetting apparatus configured to interact with the operating lever and generate a reset force for the operating lever depending on a deflection of the operating lever,
wherein a vehicle function is assigned to the operating assembly, and wherein the resetting apparatus is configured to generate a neutral position for the operating lever that corresponds with a current activation of the vehicle function.

2. The operating assembly according to claim 1, wherein the resetting apparatus is configured to generate the neutral position for a deflection of the operating lever in an automatic mode that corresponds with a position of the operating lever during manual activation of the vehicle function.

3. The operating assembly according to claim 2, wherein deflection of the operating lever in automatic mode out of its neutral position when the vehicle function is manually activated corresponds with a deflection relative to the neutral position.

4. The operating assembly according to claim 3, wherein the deflection of the operating lever out of its neutral position while in the automatic mode deactivates the automatic mode.

5. The operating assembly according to claim 3, wherein the deflection of the operating lever out of its neutral position when in the automatic mode allows speed control while in automatic mode.

6. The operating assembly according to claim 1, wherein the neutral position of the operating lever corresponds with a current position of the vehicle function associated with the operating lever.

7. The operating assembly according to claim 6, further comprising a measuring apparatus configured to capture a current position of a component set by the vehicle function.

8. The operating assembly according to claim 7, wherein the measuring apparatus contacts the resetting apparatus.

9. A method for operating an industrial truck having an operating lever and a resetting apparatus configured to interact with the operating lever, the method comprising:
assigning a vehicle function to the operating means;
generating a reset force for the operating lever depending on its deflection; and
generating a neutral position on the operating lever, wherein the neutral position corresponds with a current activation of the vehicle function.

10. The method according to claim 9, wherein the vehicle function comprises an automatic mode, and wherein a neutral position with a fading reset force is generated in a position which corresponds with a position of the operating lever when the vehicle function is manually activated.

11. The method according to claim 10, wherein a deflection of the operating lever in the automatic mode out of its neutral position when the vehivcle function is manually activated corresponds with a deflection relative to the neutral position.

12. The method according to claim 11, wherein the automatic mode is ended by deflecting the operating lever out of its neutral position.

13. The method according to claim 11, wherein a speed for continued automatic mode by the operating lever is controlled by deflecting the operating lever out of its neutral position while in the automatic mode.

14. The method according to claim 9, wherein the neutral position of the operating lever corresponds with a current position of a component actuated by the vehicle function.

15. The method according to claim 14, wherein the current position of the component is measured.
